(19) United States
(12) Patent Application Publication
(10) Pub. No.: US 2009/0083215 A1
(43) Pub. Date: Mar. 26, 2009

(54) SYSTEM, METHOD, AND COMPUTER-READABLE MEDIUM FOR AUTOMATED SELECTION OF SAMPLING USAGE IN A DATABASE SYSTEM

(76) Inventor: Louis Burger, Escondido, CA (US)

Correspondence Address: JAMES M. STOVER;TERADATA CORPORATION, 2835 MIAMI VILLAGE DRIVE, MIAMISBURG, OH, 45342, US

(21) Appl. No.: 11/859,212

(22) Filed: Sep. 21, 2007

(51) Int. Cl. G06F 17/30

(52) U.S. Cl. 707/2; 707/E17.014

(57) ABSTRACT

A system, method, and computer readable medium that automate the selection of sampling for statistics collection in a database system are provided. Various resource usage and savings evaluations may be made to determine if a column or index is a candidate for sampling during statistics recollections. If the column is successfully evaluated as a quality candidate for sampling using resource usage and savings evaluations, one or more statistics accuracy evaluations may be made to determine if inaccuracies introduced in the statistics by sampling are tolerable. If the column is successfully evaluated as a quality candidate for sampling using the statistics accuracy evaluations, the column may be designated for sampling during statistics recollections on the column. A column or index is thereby identified or eliminated for sampling and designated as such in an automated manner without manual designation or specification by a database management administrator.

### BACKGROUND

A database is a collection of stored data that is logically related and that is accessible by one or more users or applications. A popular type of database is the relational database management system (RDBMS), which includes relational tables made up of rows and columns (also referred to as tuples and attributes). Each row represents an occurrence of an entity defined by a table, with an entity being a person, place, thing, or other object about which the table contains information.

One of the goals of a database management system is to optimize the performance of queries for access and manipulation of data stored in the database. Given a target environment, an optimal query plan is selected, with the optimal query plan being the one with the lowest cost (e.g., response time) as determined by an optimizer. The response time is the amount of time it takes to complete the execution of a query on a given system.

Query optimizers in relational database management systems rely on statistics to accurately choose an efficient execution plan. Typically, an optimizer calculates cost and/or other useful metrics based on statistics of one or more columns (or attributes) of each table. In some cases, statistics are stored in the form of a histogram. In database systems that store large tables, the cost of collecting statistics for such large tables can be quite high, especially if all rows of a table need to be scanned to collect the statistics. As a result, some database users may choose not to collect statistics for columns of tables over a certain size. The lack of statistics for some tables may adversely affect operation of certain components in the database system, such as the optimizer and other tools.

Over time, statistics often become stale as the corresponding data is subjected to updates. The process of recollecting statistics usually requires scanning and sorting all of the indexed or column data and is thus resource intensive, especially for large tables. As a result, users often wish to limit recollections to only when necessary, namely when the data demographics have changed significantly. Unfortunately, it is often difficult for users to manually determine the need for recollections. This is particularly true in the case of periodic batch load operations that can be done as frequently as once per day.

To reduce the overhead of recollecting optimizer statistics, many database systems offer a sampling option that scans only a small percentage of the indexed or column data. Although sampling can offer dramatic resource savings during the collection process, its potential drawback is the loss of accuracy in the resulting statistics. In turn, inaccurate statistics impact the quality of execution plans chosen by the optimizer. In general, sampling is an ideal solution when it provides significant resource savings during collections while still producing reasonably accurate statistics.

To assist users in making the decision of when to use sampling, database vendors typically publish guidelines in their user manuals or educational material. Unfortunately, the application of such guidelines often requires intimate knowledge of the underlying data distribution, e.g., skewed vs. uniform. Furthermore, by their very nature, such guidelines are general and cannot possibly account for all of the specific factors that determine whether sampling produces accurate statistics. Moreover, many database implementations require hundreds, if not thousands, of separate statistic collections, and it is unreasonable to expect users to manually decide whether sampling is appropriate for each statistics collection.

### SUMMARY

Embodiments disclosed herein provide a system, method, and computer readable medium for automating the selection of sampling for statistics collection in a database system. Various resource usage and savings evaluations may be made to determine if a column or index is a candidate for sampling during statistics recollections. If the column is successfully evaluated as a quality candidate for sampling using resource usage and savings evaluations, one or more statistics accuracy evaluations may be made to determine if inaccuracies introduced in the statistics by sampling are tolerable. If the column is successfully evaluated as a quality candidate for sampling using the statistics accuracy evaluations, the column may be designated for sampling during statistics recollections on the column. Advantageously, a column or index is identified or eliminated for sampling and designated as such in an automated manner without manual designation or specification by a database management administrator.

### BRIEF DESCRIPTION OF THE DRAWINGS

Aspects of the present disclosure are best understood from the following detailed description when read with the accompanying figures, in which:

FIG. 1 is a diagrammatic representation of an exemplary network system in which a database management system featuring automated selection of sampling usage may be implemented in accordance with an embodiment;

FIG. 2 is a diagrammatic representation of an exemplary embodiment of a massively parallel processing system depicted in FIG. 1;

FIG. 3 is a diagrammatic representation of a database management system that facilitates automated selection of sampling usage implemented in accordance with an embodiment;

FIG. 4 is a diagrammatic representation of data dictionary depicted in FIG. 3 that facilitates automated selection of sampling usage implemented in accordance with an embodiment;

FIG. 5 is a flowchart that depicts a statistics collection and sampling evaluation routine for a column in accordance with an embodiment;

FIG. 6 is a flowchart that depicts a resource savings evaluation subroutine for evaluating the reduced resource consumption realized by sampling a column in accordance with an embodiment;

FIG. 7 is a flowchart that depicts a sampling accuracy evaluation subroutine for evaluating the accuracy of statistics collected using sampling for a column in accordance with an embodiment; and

FIG. 8 is a flowchart that depicts a statistics recollection routine for recollecting statistics of a column in accordance with an embodiment.

### DETAILED DESCRIPTION

It is to be understood that the following disclosure provides many different embodiments or examples for implementing different features of various embodiments. Specific examples of components and arrangements are described below to simplify the present disclosure. These are, of course, merely examples and are not intended to be limiting.

In accordance with embodiments, automated mechanisms that determine when sampling is effective for collecting database statistics is provided. The automated statistics collection mechanisms described herein effectively account for the resource savings as well as the impact to the accuracy of the statistics realized from using sampling.

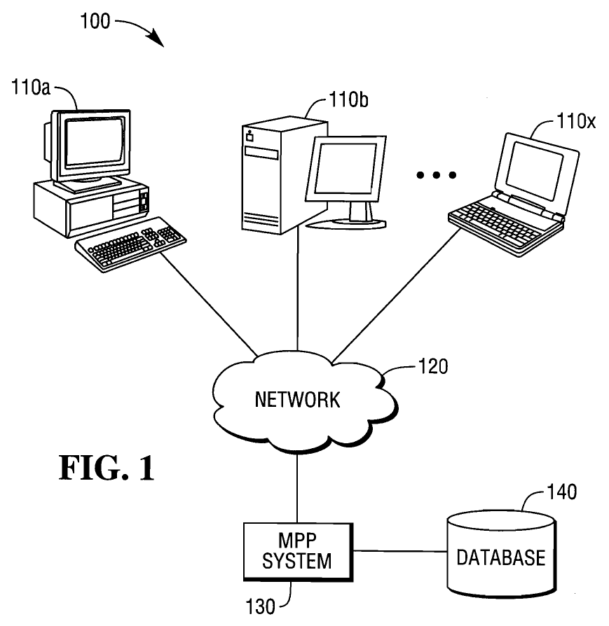

FIG. 1 is a diagrammatic representation of an exemplary network system 100 in which a database management system featuring automated selection of sampling usage may be implemented in accordance with an embodiment. The system 100 includes any number of clients 110a-110x interconnected via a network 120. Also connected to the network 120 is a massively parallel processing (MPP) system 130 that runs a database management system. The MPP system 130 may host or otherwise interface with a database 140.

The clients 110a-110x may include general purpose computing devices, such as desktop and laptop computers, personal digital assistants, and other data processing systems. Each of the clients 110a-110x may also include one or more server computers. Applications that execute on the clients 110a-110x may access the database 140 managed by the MPP system 130.

The MPP system 130 manages data stored in the database 140. The database 140 may be located on the MPP system 130 or one or more other computing devices interconnected with the MPP system 130, e.g., via the network 120 or another network. In some embodiments, the database 140 may be implemented as a relational database. Accordingly, the MPP system 130 may run a relational database management system (RDBMS). Management of the database 140 is typically performed by various processes within the database management system run by the MPP system 130.

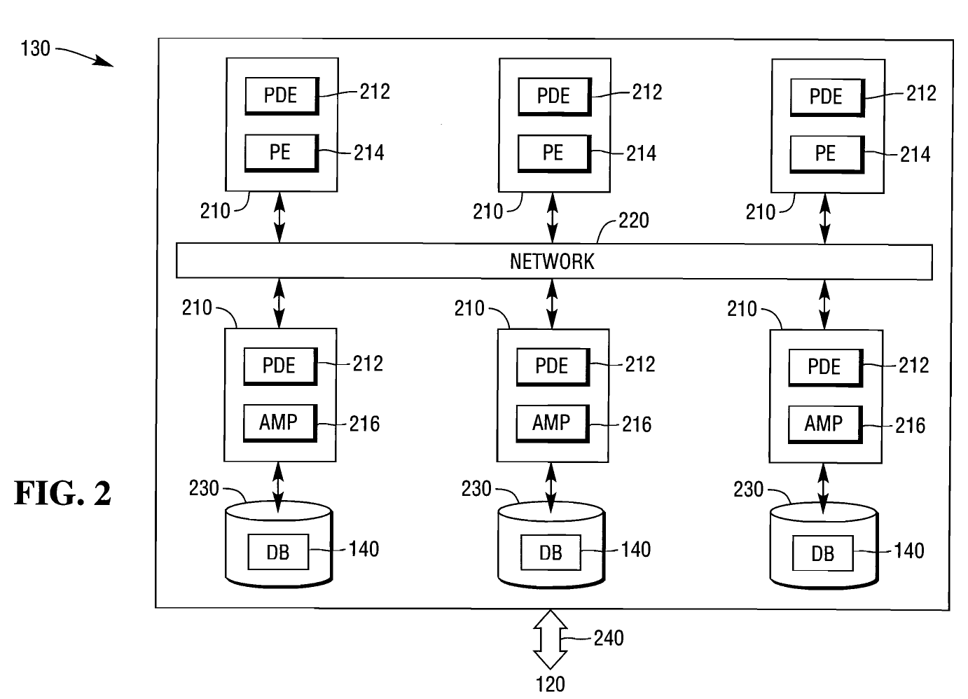

FIG. 2 is a diagrammatic representation of an exemplary embodiment of the MPP system 130 depicted in FIG. 1. Code or instructions facilitating automated selection of sampling usage implemented in accordance with an embodiment may be maintained or accessed by the MPP system 130 and run thereby.

The MPP system 130 is comprised of one or more processing units (PUs) 210, also known as processors or nodes, which are interconnected by a network 220. Each of the PUs 210 is coupled to zero or more fixed and/or removable data storage units (DSUs) 230, such as disk drives, that store one or more relational databases 140. Further, each of the PUs 210 may be coupled to zero or more data communications units (DCUs) 240, such as network interfaces, that communicate with one or more remote systems or devices, e.g., via the network 120 depicted in FIG. 1.

Operators of the MPP system 130 typically use a client, such as one of the clients 110a-110x, or other input device to interact with the MPP system 130. This interaction generally comprises statements that conform to the Structured Query Language (SQL) standard, and extensions thereto, and invoke functions performed by a RDBMS executed by the system 130.

The RDBMS may include one or more Parallel Database Extensions (PDEs) 212, Parsing Engines (PEs) 214, and Access Module Processors (AMPs) 216. These components of the RDBMS perform the functions necessary to implement the RDBMS and SQL functions, i.e., definition, compilation, interpretation, optimization, database access control, database retrieval, and database update.

Generally, the PDEs 212, PEs 214, and AMPs 216 comprise instructions and/or data that are tangibly embodied in and/or accessible from a device or media, such as RAM, ROM, one or more of the DSUs 240, and/or a remote system or device communicating with the system 130 via one or more of the DCUs 240. The PEs 214 handle communications, session control, optimization and query plan generation and control, while the AMPs 216 handle actual database 140 manipulation. Preferably, the PEs 214 fully parallelize all functions among the AMPs 216. The PDEs 212, PEs 214, and the AMPs 216 each comprise instructions and/or data which, when executed, invoked, and/or interpreted by the PUs 210 of the system 130, cause the necessary steps or elements of embodiments disclosed herein to be performed.

Those skilled in the art will recognize that the exemplary environment illustrated in FIG. 2 is not intended to limit the present disclosure. Indeed, those skilled in the art will recognize that other alternative environments may be used without departing from the scope of disclosed embodiments, and the hardware depicted in FIG. 2 may vary. In addition, it should be understood that the disclosed embodiments may also apply to components other than those disclosed herein. The depicted example is not intended to imply architectural limitations with respect to implementations of the present disclosure, but rather embodiments disclosed herein may be run by any suitable data processing system.

FIG. 3 is a diagrammatic representation of a database management system 300 that facilitates automated selection of sampling usage implemented in accordance with an embodiment. The database management system 300 may be implemented as code or instructions implemented on a computer-readable medium executable by a processing system, such as the system 130 depicted in FIGS. 1 and 2.

In the illustrative example, the database management system 300 includes a data dictionary 310 that may be utilized by other processes or modules of the database management system 300. The Data dictionary 310 may be implemented as, for example, a file, table, or other suitable data structure that defines the basic organization of the database 140. The data dictionary 310 also may include a list of all files, tables, or other data structures in the database 140, the number of records in each data structure, and the names and types of each field in each data structure. The data dictionary 310 does not contain any actual data from the database 140. Rather, the data dictionary 310 maintains bookkeeping information, typically in the form of metadata, that is used by processes of the database management system 300 in managing the database 140. The metadata of the data dictionary 310 commonly includes statistics that describe the data including statistics that describe distributions of data and other statistics that are used to generate execution plans when users or processes access data within the database 140. Statistics may be collected and maintained for many different portions of the database 140 including indexes, tables, and specific columns within tables.

The processes of the database management system 300 may also include, among others, a bulk load utility 320, a query optimizer 330, and a statistics update utility 340. The bulk load utility 320 is a utility that operates to facilitate loading of data, typically in large volumes, to the database 140. The query optimizer 330 comprises a utility that attempts to determine the most efficient way to execute a query. The optimizer 330 may evaluate possible query plans for a particular input query and attempt to determine which query plan will result in the most efficient query execution. The optimizer 330 may assign an estimated “cost” to each possible query plan and choose the plan with the smallest cost. Costs are used to estimate the runtime cost of evaluating the query, in terms of the number of requisite input/output operations, CPU requirements such as processing time, or other factors. In general, once a query is submitted to the database management system 300, the query is parsed and conveyed to the query optimizer 330 where optimization occurs.

The statistics update utility 340 operates to update statistics within the data dictionary 310. The statistics update utility 340 may update database statistics by performing a full scan, e.g., an evaluation of every data element of a particular column or index, and update the statistics based on the full scan. Alternatively, the statistics update utility 340 may update statistics of a particular column or index by sampling the column or index, i.e., by scanning a portion of the column or index, and then scaling the sampled statistics according to the sample size. The accuracy of sampled statistics may be affected by the data distribution of the sampled data. For example, data that is highly skewed may result in significant inaccuracies when employing sampling for collecting statistics.

The query optimizer 330 typically utilizes statistics from the data dictionary 310 to choose an efficient execution plan for servicing each query. However, if the statistics are not current, the query optimizer is unlikely to choose an efficient execution plan. Moreover, if the statistics are generated by sampling, and the sampling resulted in significant inaccuracies of the collected statistics, the execution plan selected by the query optimizer 330 may be inefficient. In accordance with embodiments disclosed herein, automated mechanisms that determine when sampling is effective for collecting database statistics are provided. The automated statistics collection mechanisms effectively consider the resource savings from sampling as well as the impact to the accuracy of the statistics.

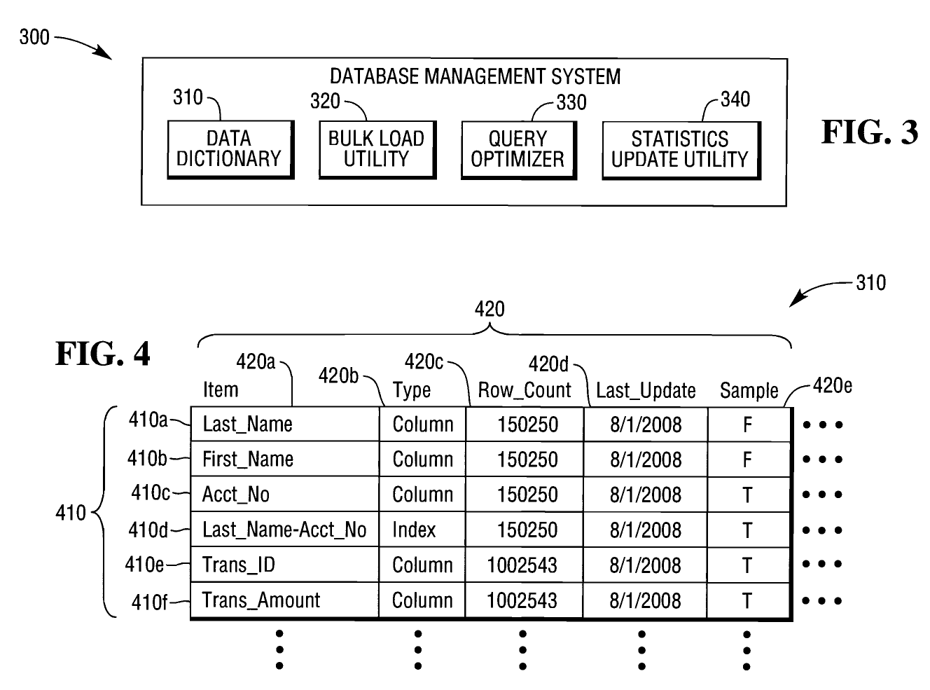

FIG. 4 is a diagrammatic representation of the data dictionary 310 depicted in FIG. 3 that facilitates automated selection of sampling usage implemented in accordance with an embodiment. In the illustrative example, the data dictionary 310 comprises a table although other data structures may suitably be substituted therefor.

The data dictionary 310 comprises a plurality of records 410a-410f (collectively referred to as records 410) and fields 420a-420e (collectively referred to as fields 420). The dictionary 310 may be stored on a disk drive, fetched therefrom by a processor of the MPP system 130, and processed thereby.

Each of the records 410a-410f specifies characteristics of a particular column or index of the database 140. In the present example, the records 410a-410f specify characteristics of database items “Last_Name”, “First_Name”, “Acct_No”, Last_Name_Acct_No”, “Trans_ID”, and “Trans_Amount” as indicated by values of the Item field 420a in respective records 410a-410f. The Type field 420b stores values that indicate an item type, e.g., a column or index, of an item specified in the Item field 420a of a corresponding record 410. Thus, for example, the item “Last_Name” comprises a database column, and the item Last_Name-Acct_No comprises an index.

The data dictionary 310 may include any variety of information regarding database items. In the present example, the data dictionary 310 includes a Row_Count field 420c that specifies the number of rows or records corresponding to a respective item of the Item field 420 maintained in the database 140, and a Last_Update field 420d that specifies a date at which a corresponding item has most recently been updated. In accordance with an embodiment, the data dictionary 310 also includes a Sample field 420e that specifies whether a corresponding item, e.g., a column or index, has been evaluated as an appropriate item for sampling when recollecting statistics on the corresponding item. In the illustrative example, the Sample field 420e is assigned a Boolean value of True (“T”) if the corresponding item has been designated for sampling, and a Boolean value of False (“F”) if the corresponding item has not been designated for sampling and thus requires a full scan when recollecting statistics on the item. Any number of other metadata or database characteristics may have fields allocated in the data dictionary 310 in addition to, or in lieu of, those depicted, and the exemplary fields of the data dictionary 310 are illustrative only.

Administrators may cause statistics to be collected in the database management system 300 on a specified column or index of a table using, for example, the statement “COLLECT STATISTICS” or an equivalent statement as shown below. This command, in typical embodiments, will cause the statistics update utility 340 to scan and sort the underlying data to generate the frequency for each distinct value which in turn will be used to, for example, build an equi-height histogram that is stored in, or in conjunction with, the data dictionary 310.

/* Perform the initial collection on a given index or column */
COLLECT STATISTICS [USING SAMPLE] ON <table_name>
<column_or_index>;

This command will scan and sort the underlying data to generate the frequency for each distinct value which in turn will be used to build a histogram that is stored in the data dictionary 310 where it can be accessed by the query optimizer 330 during query optimization. If the optional USING SAMPLE clause is specified, then only a small percentage of the data is scanned and the resulting sampled statistics are scaled to reflect the entire data set.

Previously collected statistics can then be recollected by omitting a specific column or index in the syntax:

/* Recollect all previously specified columns and indexes
on a given table */
COLLECT STATISTICS ON <table_name>;

The above statement determines which columns and indexes currently have statistics for the specified table, and then performs a recollection on each of them. If the prior collection included the use of the USING SAMPLE option, this option is applied again during the recollection. Hence, any sampling option specified during the initial collection is always honored during recollections. Those skilled in the art will recognize that the described COLLECT STATISTICS syntax is exemplary only, and any command variation suitable for invoking a statistics collection or recollection process in a database system may be substituted for the described commands. Further, it is understood by those skilled in the art that the various command syntax depicted and described herein is exemplary and is provided to facilitate an understanding of the disclosed embodiments, and implementations of the described commands may be dependent on the particular database system in which embodiments disclosed herein are deployed.

In conventional database management systems, an administrator must determine whether to specify the USING SAMPLE option when first collecting statistics on a given column or index. As discussed hereinabove, a potential drawback of such an implementation is the loss of accuracy in the resulting statistics is the specified column or index is not a good candidate for sampling, for example if the data of the column or index is highly skewed, or if sampling does not provide significant resource savings.

Two important observations are advantageously leveraged to provide an automated selection of sampling usage in accordance with disclosed embodiments: (1) the performance of recollections is much more important than the performance of the initial collection, and (2) although the data and the resulting statistics change between recollections, the decision of whether to use sampling on a given index or column is not likely to change between recollections. The specific data for a given column or index may change over time but the overriding characteristics that make it a quality candidate for sampling, for example the nature of the value distribution and the overall size, are not likely to change.

In accordance with an embodiment, the statistics update utility 340 performs two separate statistics collections during an initial collection—a statistics collection utilizing sampling and a statistics collection that does not utilize sampling but rather performs a fall scan. The statistics update utility 340 may then compare the resources consumed, e.g., elapsed times, for the two collections to determine the savings from sampling. If significant savings are realized, a comparison of the statistics generated from sampling and those from the full scan which represent the actual, or correct, statistics is made to determine the level of inaccuracy introduced by sampling. If the inaccuracies are tolerable, sampling will be performed during all subsequent recollections of the particular column or index. To this end, the Sample field 420e is assigned a value that indicates whether sampling is to be used for statistics recollection of the column or index.

The following exemplary syntax extension may be introduced to the COLLECT STATISTICS statement to facilitate automated selection of sampling usage:

/* Determine whether sampling should be used on a given index or
column */
COLLECT STATISTICS ON <table_name> <column_or_index>

[ANALYZE SAMPLING];

The ANALYZE SAMPLING option informs the database management system 300 that it should automatically determine whether sampling should be performed for the specified index or column, and this decision should be recorded in the dictionary, e.g., via the Boolean Sample field 420e, and honored during subsequent recollections. If sampling is chosen as the preferred method, the sampled statistics collected by this statement are stored in the dictionary. Otherwise, the regular full-scan statistics are stored. In this manner, the system consistently uses either sampled or full-scan statistics for a particular column or index and ensures that the effects from sampling on query optimization are immediately realized. Once a value has been assigned to the Sample field 420e for a column or index, a recollection of statistics using the COLLECT STATISTICS ON <table_name> statement results in recollection of statistics for columns or indexes of the specified table that have previously had statistics collected. Notably, the recollection performed by the COLLECT STATISTICS ON <table_name> statement honors the sampling designation of the Sample field 420e for each column or index for which statistics are recollected. Advantageously, the initial statistics collection using the ANALYZE SAMPLING option results in the automated selection of sampling for columns or indexes that have been evaluated as suitable candidates for sampling during recollection of statistics.

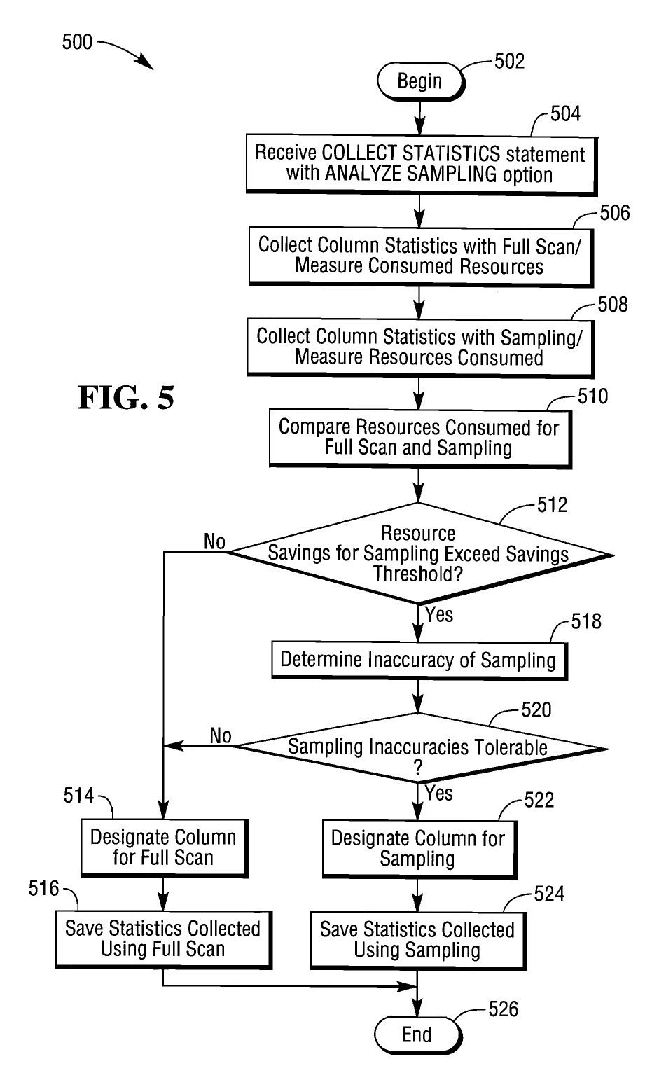

In the following description of statistics collection, recollection, and various performance evaluations described in FIGS. 5-8, reference is made to statistics collections and evaluations made with respect to a database column. It is understood, however, that the described procedures may be implemented in a similar manner for a database index that may be defined on one or more database columns. Furthermore, the described processes may be extended to accommodate other data structures, such as materialized views that comprise indexing structures derived from query results, or to other data structures as will be recognized by skilled artisans.

FIG. 5 is a flowchart 500 that depicts a statistics collection and sampling evaluation routine for a column in accordance with an embodiment. The processing steps of FIG. 5 may be implemented as computer-executable instructions, e.g., implemented in the statistics update utility 340, executable by a processing system, such as the MPP system 130 depicted in FIGS. 1 and 2.

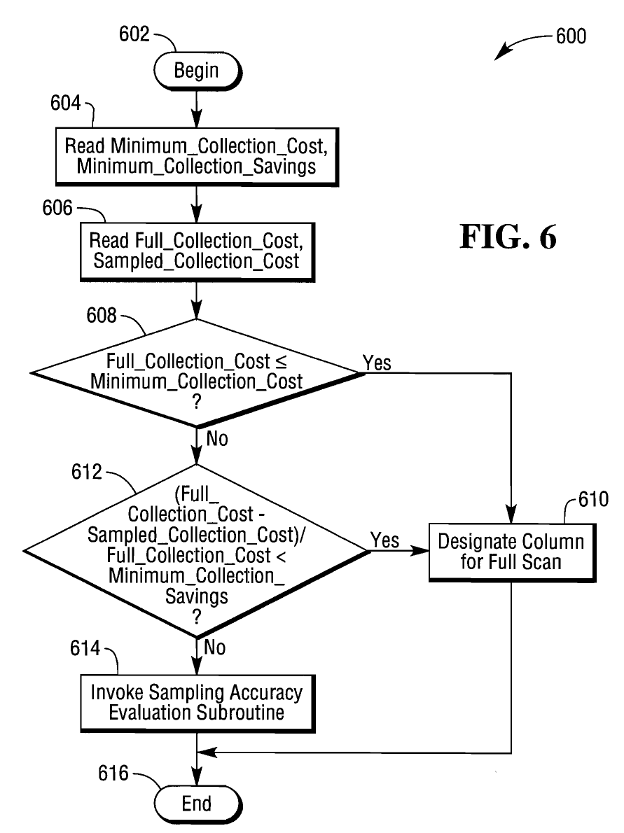

The sampling evaluation routine is invoked (step 502), and a COLLECT STATISTICS statement that includes an ANALYZE SAMPLING option is received that specifies a particular table column (step 504). Statistics of the specified column are collected using a full scan by evaluating each of a plurality of values of the column, and a measurement of the system resources consumed for the statistics collection is made (step 506). The statistics collected using a full scan may include each distinct value of the column. The set of distinct values of a column identified by a full scan is herein designated DV_{fs}. Additionally, the statistics collected using a full scan may include a set of loner values. The set of loner values of a column identified by a full scan is herein designated L_{fs}. The measurement of the consumed resources may comprise a processing duration, the number of I/O operations utilized for the statistics collection, or another suitable resource metric. A separate statistics collection is then performed on the column using sampling during which a subset that comprises less than each of the plurality of values of the column are evaluated, and a measurement of the system resources consumed for the statistics collection is made (step 508). The statistics collected using sampling may include distinct values of the column and a set of loner values. The set of distinct values of a column identified by sampling is herein designated DVₛₐₘₚₗₑ, and the set of loner values of a column identified by sampling is herein designated Lₛₐₘₚₗₑ. The measurement of the resources consumed during the statistics collection using a full scan is then compared with the measurement of the resources consumed during the statistics collection using sampling (step 510). For example, processing time consumed for the statistics collection using the full scan may be compared with the processing time consumed for the statistics collection using sampling. An evaluation may then be made to determine if the resource saving realized by using sampling exceeds a pre-defined savings threshold (step 512) as described more fully hereinbelow with reference to FIG. 6. In the event that the resource savings do not exceed the savings threshold, the column may then be designated for a full scan for future statistics recollections (step 514). For example, a Boolean False may be assigned in the Sample field 420e of the record allocated for the column for which the statistics collection and sampling evaluation was performed. The statistics collected using the full scan may then be saved (step 516), and the statistics collection and sampling evaluation routine cycle may then end (step 526).

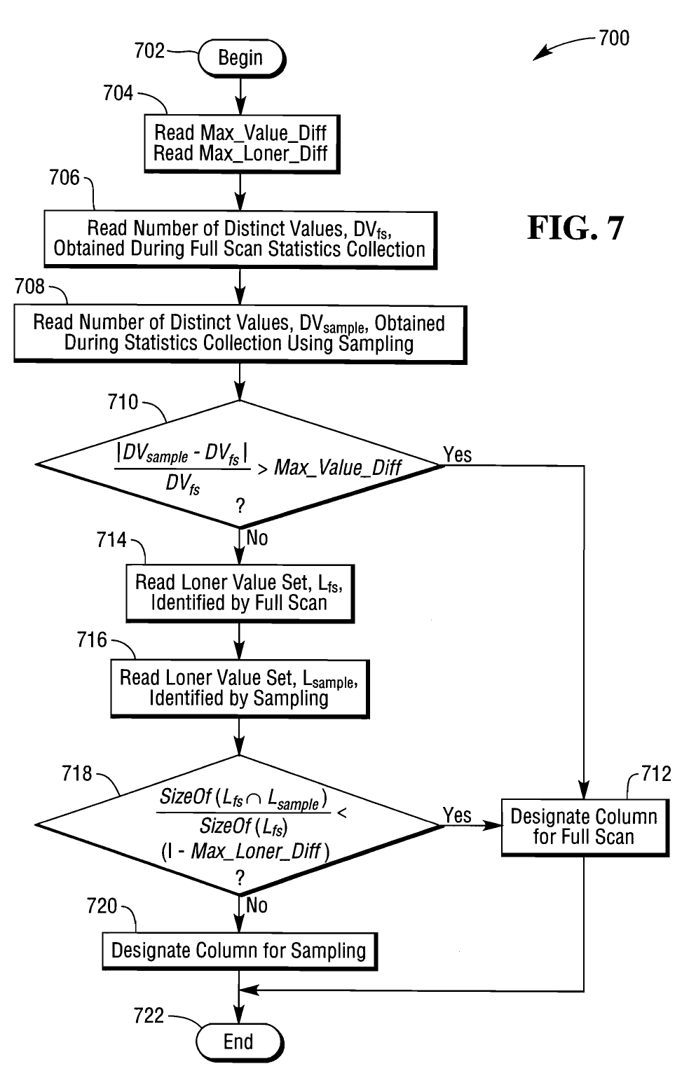

Returning again to step 512, in the event that the resource savings obtained by sampling exceed the savings threshold, a measurement of the inaccuracy of the statistics introduced by sampling may be made (step 518). The inaccuracy evaluation may include, for example, a comparison of the actual number of distinct values of the column as determined by the full scan with the number of distinct values of the column identified by sampling. The inaccuracy evaluation may likewise include a comparison of the actual number of loner values of the column as determined by the full scan with the number of loner values of the column identified by sampling. Other accuracy evaluations may be made in addition to, or in lieu of, an evaluation of the distinct values and loner values determined by the full scan and sampling. An evaluation may then be made to determine if the inaccuracies introduced by sampling are tolerable (step 520) as described more fully hereinbelow with reference to FIG. 7. If it is determined that the sampling inaccuracies are not tolerable, the sampling evaluation routine may proceed to designate the column for a full scan for future statistics recollections according to step 514. If, however, the inaccuracies are determined to be tolerable at step 520, the column may be designated for sampling (step 522). For example, a Boolean True may be assigned in the Sample field 420e of the record allocated for the column for which the statistics collection sampling evaluation was performed. In this manner, the column is designated for sampling during statistics recollections on the column in an automated manner. The statistics collected using sampling may then be saved (step 524), and the statistics collection and sampling evaluation routine cycle may then end according to step 526.

FIG. 6 is a flowchart 600 that depicts a resource saving evaluation subroutine for evaluating the reduced resource consumption realized by sampling a column in accordance with an embodiment. The processing steps depicted in FIG. 6 are an example embodiment of a subroutine that may be implemented for performing the resource savings evaluation process described with reference to step 512 of FIG. 5. The processing steps of FIG. 6 may be implemented as computer-executable instructions, e.g., implemented in the statistics update utility 340 depicted in FIG. 3, executable by a processing system, such as the MPP system 130 depicted in FIGS. 1 and 2.

The resource savings evaluation subroutine is invoked (step 602), and a minimum resource consumption threshold (designated Minimum_Collection_Cost) as well as a sampling collection savings threshold (designated Minimum_Collection_Savings) are read (step 604). The Minimum_Collection_Cost threshold specifies a resource usage for a full column or index scan below which sampling is not to be designated for statistics recollections of the column. The Minimum_Collection_Cost threshold may comprise a pre-defined value, e.g., 1 second, and may be user-configurable. The Minimum_Collection-Savings threshold defines a resource savings threshold that is to be obtained by sampling in order for a column to be designated for sampling for statistics recollections of the column. The Minimum_Collection_Savings threshold may be defined as a percentage of the resource usage consumed for a full scan.

The resource savings evaluation subroutine may then read a measurement of the resource consumption utilized during a full column scan (designated Full_Collection_Cost) and the resource consumption utilized during sampling the column (designated Sampled_Collection_Cost) (step 606). An evaluation may then be made to determine if the resource consumption of the full scan is less or equal to the minimum resource consumption threshold (step 608). If the resource consumption for the full scan is equal or less than the minimum resource consumption threshold, the resource evaluation subroutine may designate the column for a full scan (step 610). For example, a Boolean False setting maybe set in the Sample field 420e of the data dictionary 310 for the column. The resource savings evaluation subroutine cycle may then end (step 616).

Returning again to step 608, in the event that the resource consumption for the full scan exceeds the minimum resource consumption threshold, the resource evaluation subroutine may proceed to determine whether sampling of the statistics has provided a resource savings that equals or exceeds the sampling collection savings threshold (step 612). If the resource savings are less than the sampling collection savings threshold required for sampling, the evaluated column may be designated for automated full scanning according to step 610, e.g., by setting a Boolean False value in the Sample field 420 of the data dictionary 310 for the evaluated column. If the resource savings equal or exceed the sampling collection savings threshold required for sampling, a sampling accuracy evaluation subroutine described more fully hereinbelow with reference to FIG. 7 may be invoked to determine whether the sampled statistics are sufficiently accurate to designate the column for sampling during statistics recollections of the column.

Accuracy is determined by comparing one or more key statistical values that describe a given value distribution. For example, the total number of distinct values that are estimated via sampling may be required to be within a certain degree of error, namely plus or minus a particular percent such as 25 percent. In addition, an accuracy evaluation algorithm or subroutine may recognize the importance of correctly identifying high frequency or “Loner” values during sampling. The presence or absence of Loner values is the single greatest factor in determining whether a value distribution is skewed. A given value may be deemed a Loner if its frequency is greater than L percent of the total number of rows where the default for L is, for example, 0.005 ( 1/200). Hence, as a second requirement, the accuracy evaluation subroutine may require the statistics produced by sampling the column to correctly identify a predefined amount, e.g., two thirds, of the actual Loners as identified by the full scan collection. The requisite pre-defined amount of identified Loners may be user-configurable. Of course, other value metrics may be substituted for the distinct values and/or Loner values that are evaluated for making a determination of the accuracy of statistics produced from sampling. For example, one or more mode, rather than Loner, values may be identified by the full scan and by sampling, and an accuracy evaluation may be made by a comparison of a mode value produced by a full scan with a mode value produced by sampling. Other data value metrics may be identified for a full scan and sampling, and other evaluation processes may be implemented to ascertain the accuracy yielded by sampling without departing from the embodiments disclosed herein.

FIG. 7 is a flowchart 700 that depicts a sampling accuracy evaluation subroutine for evaluating the accuracy of statistics collected using sampling for a column in accordance with an embodiment. The processing steps depicted in FIG. 7 are an example embodiment of a subroutine that may be implemented for performing the sampling inaccuracies evaluation process depicted and described with reference to step 520 of FIG. 5. The processing steps of FIG. 7 may be implemented as computer-executable instructions, e.g., implemented in the statistics update utility 340 depicted in FIG. 3, executable by a processing system, such as the MPP system 130 depicted in FIGS. 1 and 2.

The sampling accuracy evaluation subroutine is invoked (step 702), and a maximum value differential threshold (designated Max_Value_Diff) as well as a maximum loner differential threshold (designated Max_Loner_Diff) are read (step 704). The maximum value differential threshold specifies a margin that the number of distinct values obtained by sampling must be within the actual number of distinct values as determined by a full scan for the column to be designated for sampling during statistic recollections. The maximum value differential threshold may, for example, specify that the number of distinct values identified by sampling is within fifty percent of the actual number of distinct values as determined by a full scan of the column. The maximum loner differential threshold specifies a margin that the number of loner values determined by sampling must be within the actual number of loner values as determined by a full scan for the column to be designated for sampling during statistics recollections. The maximum loner differential threshold may, for example, specify that the loner values identified by sampling include at least two-thirds of the actual loner values as determined by a full scan of the column. The maximum value differential and the maximum loner differential may be user-configurable values.

The number of distinct values, DV_{fs}, identified in the column utilizing a full scan is read (step 706), and the number of distinct values, DVₛₐₘₚₗₑ, obtained by sampling the column is read (step 708). An evaluation is then made to determine if the number of distinct values obtained by sampling is within the maximum value differential threshold of the actual number of distinct values as identified by the full scan (step 710). If the percentage of distinct values identified by sampling exceeds the maximum value differential threshold thereby indicating that the number of distinct values identified by sampling is not within the maximum value differential threshold, the column may be designated for full scan for statistics recollections (step 712), e.g., by setting a Boolean False value in the Sample field 420e of data dictionary 310 for the column. The sampling accuracy evaluation subroutine cycle may then end (step 722).

Returning to step 710, if the percentage of distinct values identified by sampling is within the maximum value differential threshold, the set of loner values, L_{fs}, identified in the column utilizing a full scan is read (step 714), and the set of loner values, Lₛₐₘₚₗₑ, obtained by sampling the column is read (step 716). An evaluation is then made to determine if the loner value set, Lₛₐₘₚₗₑ, includes a threshold percentage, as specified by the maximum loner differential threshold, of the loner values identified in the loner value set, L_{fs}, collected with the full scan (step 718). In the illustrative example, the maximum loner differential threshold may be set to 0.33, and thus the number of loner values of the sampled loner value set, Lₛₐₘₚₗₑ, must equal or exceed two-thirds of the actual loner values of the loner value set L_{fs} obtained by the full scan. If the sampled loner values are not within the specified threshold of the actual loner values, the column may be designated for full scan for statistics recollections according to step 712. If the sampled loner values are within the specified threshold, the column may be designated for sampling for statistics recollections (step 720), e.g., by setting a Boolean True value in the Sample field 420e of the data dictionary 310 for the column. The sampling accuracy evaluation subroutine cycle may then end according to step 722.

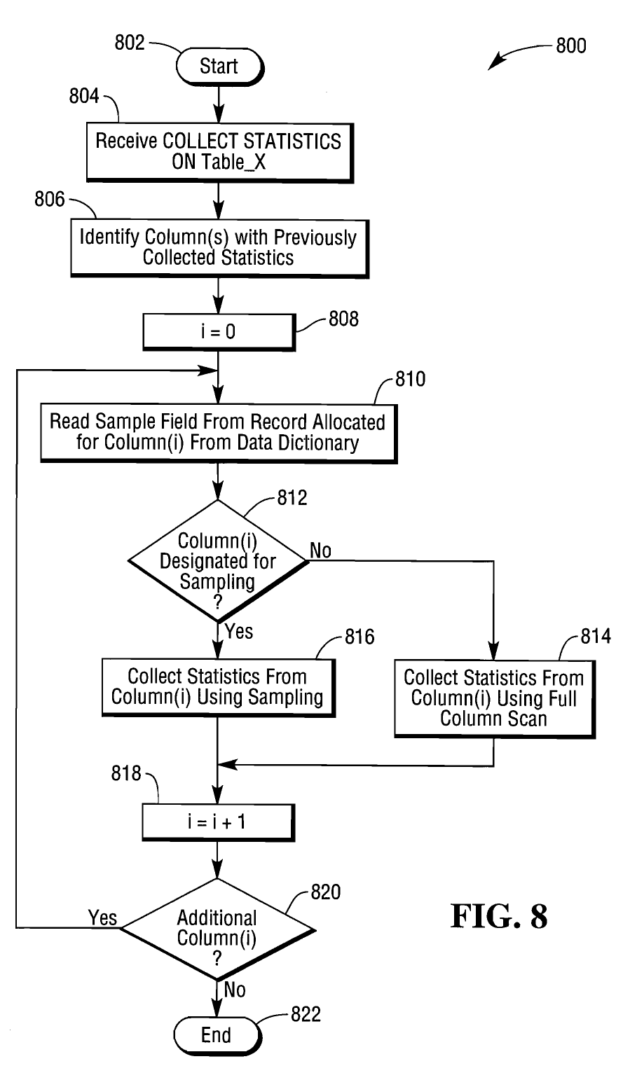

FIG. 8 is a flowchart 800 that depicts a statistics recollection routine for recollecting statistics of a column in accordance with an embodiment. The processing steps of FIG. 8 may be implemented as computer-executable instructions, e.g., implemented in statistics update utility 340 depicted in FIG. 3, executable by a processing system, such as the MPP system 130 depicted in FIGS. 1 and 2.

The statistics recollection routine is invoked (step 802), and a COLLECT STATISTICS command that specifies a particular table (illustratively designated Table_X) is received (step 804). Columns of the specified table that have previously had statistics collected are identified (step 806), and an index, i, may be initialized (step 808). The Sample field 420e of the record allocated in the data dictionary 310 for column(i) of the identified column(s) is then read (step 810). An evaluation is then made to determine if column(i) is designated for sampling (step 812), e.g., by determining if the Sample field 420e of the data dictionary record allocated for column(i) is set to True. In the event that the column is not designated for sampling, the statistics update utility may then proceed to collect statistics on the column using a full scan (step 814), and the recollection routine may then proceed to increment the index i (step 818). If column(i) is designated for sampling, the statistics update utility may then proceed to collect statistics on column(i) using sampling (step 816) and proceed to increment the index i according to step 818. An evaluation may then be made to determine if any additional column remains for statistics recollection (step 820). If another column(i) remains, the recollection routine may return to step 810 to read the sample field allocated for column(i). After recollection of statistics on all identified columns of the table, the recollection routine cycle may then end (step 822).

As described, mechanisms for automated selection of sampling for statistics recollections of a database column or index are provided. Statistics of a column or index are collected using a full scan and sampling. Various resource usage and savings evaluations may be made to determine if the column or index is a candidate for sampling during statistics recollections. If the column is successfully evaluated as a quality candidate for sampling using resource usage and savings evaluations, one or more statistics accuracy evaluations may be made to determine if the inaccuracies introduced in the statistics by sampling are tolerable. If the column is successfully evaluated as a quality candidate for sampling using the statistics accuracy evaluations, the column may be designated for sampling during statistics recollections on the column. Advantageously, a column or index is identified or eliminated for sampling and designated as such in an automated manner without manual designation or specification by a database management administrator.

The flowcharts of FIGS. 5-8 depict process serialization to facilitate an understanding of disclosed embodiments and are not necessarily indicative of the serialization of the operations being performed. In various embodiments, the processing steps described in FIGS. 5-8 may be performed in varying order, and one or more depicted steps may be performed in parallel with other steps. Additionally, execution of some processing steps of FIGS. 5-8 may be excluded without departing from embodiments disclosed herein.

The illustrative block diagrams and flowcharts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like.

Aspects of the present disclosure may be implemented in software, hardware, firmware, or a combination thereof. The various elements of the system, either individually or in combination, may be implemented as a computer program product tangibly embodied in a machine-readable storage device for execution by a processing unit. Various steps of disclosed embodiments may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying aspects of described embodiments can be loaded onto a computer. The computer program is not limited to any particular embodiment, and may, for example, be implemented in an operating system, application program, foreground or background process, or any combination thereof, executing on a single processor or multiple processors. Additionally, various steps of disclosed embodiments may provide one or more data structures generated, produced, received, or otherwise implemented on a computer-readable medium, such as a memory.

Although embodiments of the present disclosure have been illustrated in the accompanied drawings and described in the foregoing description, it will be understood that the disclosure is not limited to the embodiments disclosed, but is capable of numerous rearrangements, modifications, and substitutions without departing from the spirit of the disclosure as set forth and defined by the following claims. For example, the capabilities of the disclosed embodiments can be performed fully and/or partially by one or more of the blocks, modules, processors or memories. Also, these capabilities may be performed in the current manner or in a distributed manner and on, or via, any device able to provide and/or receive information. Further, although depicted in a particular manner, various modules or blocks may be repositioned without departing from the scope of the current disclosure. Still further, although depicted in a particular manner, a greater or lesser number of modules and connections can be utilized with the present disclosure in order to accomplish the described embodiments, to provide additional known features, and/or to make disclosed embodiments more efficient. Also, the information sent between various modules can be sent between the modules via at least one of a data network, an Internet Protocol network, a wireless source, and a wired source and via a plurality of protocols.

What is claimed is:

1. A method of collecting statistics in a database management system, the method comprising:
collecting statistics of a column comprising a plurality of values using a full scan that includes an evaluation of each of the plurality of values;
collecting statistics of the column using sampling that includes an evaluation of a subset of the plurality of values, wherein the subset comprises a number of values less than the plurality of values;
comparing a first resource usage consumed by collecting statistics using the full scan with a second resource usage consumed by collecting statistics using sampling; and
providing a designation for the column that specifies whether sampling is to be used for a subsequent statistics recollection procedure on the column.

2. The method of claim 1, further comprising comparing the first resource usage with a minimum resource usage threshold, wherein the designation specifies sampling is not to be used when the first resource usage is equal to or less than the minimum resource usage threshold.

3. The method of claim 1, wherein comparing the first resource usage and the second resource usage farther comprises identifying the second resource usage as providing a resource savings equaling or exceeding a threshold percentage of the first resource usage, and wherein the designation specifies sampling is to be used.

4. The method of claim 1, wherein comparing the first resource usage and the second resource usage further comprises identifying the second resource usage as failing to provide a resource savings equaling or exceeding a threshold percentage of the first resource usage, and wherein the designation specifies sampling is not to be used.

5. The method of claim 1, further comprising evaluating an accuracy of the statistics collected using sampling.

6. The method of claim 5, wherein comparing the first resource usage with the second resource usage results in identifying the column as a candidate for sampling, wherein evaluating the accuracy of the statistics results in identifying the accuracy of the statistics collected as tolerable, and wherein providing the designation comprises designating the column for sampling.

7. The method of claim 5, wherein evaluating the accuracy further comprises:
comparing a first number of distinct values of the plurality of values identified using the full scan with a second number of distinct values identified using sampling; and
identifying the second number of distinct values to be within a distinct values threshold of the first number of distinct values.

8. The method of claim 5, wherein evaluating the accuracy further comprises:
reading a first set of high frequency values identified as skewed by the full scan;
reading a second set of high frequency values identified as skewed by sampling; and
identifying the second set as including a pre-defined percentage of values of the first set.

9. The method of claim 1, further comprising:
receiving a command that directs a statistics update utility to recollect statistics on the column, wherein the command does not include a directive to use sampling;
reading the designation; and
collecting statistics using sampling in response to reading the designation, wherein the designation specifies sampling is to be used for the column.

10. A database management system, comprising:
a data dictionary implemented in a machine-accessible medium including rows of metadata each associated with a respective database column of a database table, wherein at least one row includes a column that maintains a data value that specifies whether an associated database column is to be evaluated with sampling or a full column scan when recollecting statistics on the associated database column; and
a statistics update utility implemented in a machine-accessible medium adapted to be executed by a processing system, wherein the statistics update utility collects first statistics of the database column using a full scan that includes an evaluation of each of a plurality of values maintained in the database column, collects second statistics of the database column using sampling that includes an evaluation of a subset of the plurality of values, wherein the subset comprises a number of values less than the plurality of values, performs a comparison of a first resource usage consumed by collecting the first statistics with a second resource usage consumed by collecting the second statistics, and sets the data value to specify that one of sampling and a full scan is to be used for a statistics recollection on the database column based at least in part on results of the comparison.

11. The system of claim 10, wherein the statistics update utility compares the first resource usage with a minimum resource usage threshold, wherein the data value specifies sampling is not to be used when the first resource usage is equal to or less than the minimum resource usage threshold.

12. The system of claim 10, wherein the comparison of the first resource usage and the second resource usage performed by the statistics update utility further comprises identifying a resource savings provided by sampling equals or exceeds a threshold percentage of the first resource usage, and wherein the data value specifies sampling is to be used for the statistics recollection.

13. The system of claim 10, wherein the comparison of the first resource usage and the second resource usage performed by the statistics update utility further comprises identifying a resource savings provided by sampling as failing to equal or exceed a threshold percentage of the first resource usage, and wherein the data value specifies sampling is not to be used for the statistics recollection.

14. The system of claim 10, wherein the statistics update utility is further adapted to perform an evaluation of an accuracy of the second statistics collected using sampling.

15. The system of claim 14, wherein the comparison of the first resource usage with the second resource usage results in identification of the column as a candidate for sampling, wherein evaluating the accuracy of the second statistics results in identifying the accuracy as tolerable, and wherein the data value designates the column for sampling.

16. The system of claim 14, wherein the evaluation performed by the statistics update utility further comprises:
performing a comparison of a first number of distinct values of the plurality of values identified using a full scan with a second number of distinct values identified using sampling; and
identifying the second number of distinct values to be within a distinct values threshold of the first number of distinct values.

17. The system of claim 14, wherein the evaluation performed by the statistics update utility further comprises:
reading a first set of high frequency values identified as skewed by the full scan;
reading a second set of high frequency values identified as skewed by sampling; and
identifying the second set as including a pre-defined percentage of values of the first set.

18. The system of claim 10, wherein the database management system receives a command to recollect statistics on the database column that does not include a directive to use sampling, wherein the statistics update utility reads the data value and recollects statistics on the database column using sampling in response to reading the data value, and wherein the data value specifies sampling is to be used for the column.

19. A computer-readable medium having computer-executable instructions for execution by a processing system, the computer-executable instructions for managing a database, the computer-executable instructions, when executed, cause the processing system to:
collect statistics of a database column comprising a plurality of values using a full scan that includes an evaluation of each of the plurality of values;
collect statistics of the column using sampling that includes an evaluation of a subset of the plurality of values, wherein the subset comprises a number of values less than the plurality of values;
perform a comparison of a first resource usage consumed by collecting statistics using the full scan with a second resource usage consumed by collecting statistics using sampling;
perform an evaluation of an accuracy of the statistics collected using sampling; and
designate the database column for one of sampling and a full scan for statistics recollections made on the database column based on at least one of the comparison and the evaluation.

20. The computer-readable medium of claim 19, wherein the instructions that designate the database column set a data value in a record allocated for the database column of a data dictionary to designate the database column for sampling in response to the comparison identifying the second resource usage as providing an acceptable resource usage savings relative to the first resource usage, and the evaluation identifying the statistics collected using sampling as acceptable.
